(19) United States
(12) Patent Application Publication
(10) Pub. No.: US 2008/0245463 A1
(43) Pub. Date: Oct. 9, 2008

(54) GLUE APPLICATION DETECTION SYSTEM AND METHOD

(75) Inventor: Daniel A. Palla, Midlothian, VA (US)

Correspondence Address: CONNOLLY BOVE LODGE & HUTZ, LLP, P O BOX 2207, WILMINGTON, DE, 19899, US

(73) Assignee: PHILIP MORRIS USA INC., Richmond, VA (US)

(21) Appl. No.: 12/041,953

(22) Filed: Mar. 4, 2008

Related U.S. Application Data
(60) Provisional application No. 60/893,981, filed on Mar. 9, 2007.

(51) Int. Cl. B32B 41/00

(52) U.S. Cl. 156/64; 156/378

(57) ABSTRACT

A glue application method and system comprises a continuous paper substrate moving in a downstream direction along a path of travel. Glue is applied to selected portions of the upper surface of the paper substrate. A first direct contact capacitive sensor under the paper substrate upstream of glue application and in direct contact with the under surface of the substrate produces a signal representative of the dielectric constant of the paper substrate. A second direct contact capacitive sensor under the paper substrate downstream of glue application and in direct contact with the under surface of the substrate with glue thereon produces a second signal representative of the dielectric constant of the paper substrate with glue thereon. A control determines differences between the first and second signals thereby indicating that glue has been applied to the paper substrate.

### CROSS REFERENCE RELATED TO APPLICATION

The present application claims the benefit of provisional application Ser. No. 60/893,981, filed Mar. 9, 2007, for all useful purposes, and the specification and drawings thereof are included herein by reference.

### BACKGROUND OF THE INVENTION

The present invention relates to a reliable method and apparatus for detecting minute quantities of glue applied onto a paper substrate in a high speed operation.

In many instances the application of glue to a paper substrate is a critical step in a manufacturing process. For example, glue is applied to tipping paper in the manufacture of cigarette, and the tipping paper is then cut to length and wrapped around a cigarette filter and wrapped tobacco rod to thereby secure the filter to the rod. The absence of glue on the tipping paper could ultimately cause filter falloff. Detecting the presence/absence of the glue as it is applied is a preemptive measure to prevent loss of quality or product failure latter in the process.

### SUMMARY OF THE INVENTION

Accordingly, the primary object of the present invention is a reliable method and apparatus for detecting the presence/absence of minute quantities of glue on a paper substrate in a high speed operation in a highly efficient manner.

In accordance with the present invention, an endless paper substrate is traveling at a high rate of speed, and glue is applied to selected surface portions on one side of the paper. Prior to the application of glue, the paper travels over a first direct contact capacitive sensor which measures the dielectric constant of the paper and outputs a first signal representative of that measurement. After the application of glue, the paper with the glue thereon travels over a second direct contact capacitive sensor which measures the dielectric constant of both the paper and glue and outputs a signal representative of that measurement. The paper with wet glue has a demonstrable difference as opposed to dry paper or paper without glue, and this difference is utilized as an indicator that glue has in fact been applied to the paper. Without applied glue there is little or no difference between the signals, and the lack of difference is utilized as an indication of a defect which is thereafter corrected.

### BRIEF DESCRIPTION OF THE DRAWINGS

Novel features and advantages of the present invention in addition to those noted above will be become apparent to persons of ordinary skill in the art from a reading of the following detailed description in conjunction with the accompanying drawings wherein similar reference characters refer to similar parts and in which:

FIG. 1 is a schematic side elevational view of an endless paper substrate traveling at a high rate of speed and a system for detecting the presence/absence of glue applied to the substrate, in accordance with the present invention; and

FIG. 2 is a perspective diagrammatic view of one of two direct contact capacitive sensors used in the system of FIG. 1, according to the present invention.

### DETAILED DESCRIPTION OF THE INVENTION

The present invention involves a reliable method for detecting minute quantities of glue in a high speed operation. Fundamentally, the method relies on measuring the ‘relative permittivity’ or ‘dielectric constant’ of paper with wet glue applied. The formula which explains the overall sensing system can be expressed as follows:

$$C = \frac{Area \times Dielectric}{Gap}$$

One can readily see that, if the area of the sensing plates and the distance (gap) between them remains fixed, then the value of ‘C’ will change proportionately with the dielectric constant of whatever material is placed between the two plates.

| | Dielectric Constant |
|---|---|
| Material | Relative (ξᵣ) |
| Vacuum | 1.0 |
| Air | 1.0006 |
| Epoxy | 2.5-6.0 |
| PVC | 2.8-3.1 |
| Glass | 3.7-10.0 |
| Water | 80.0 |

The dielectric constant of water is such a large value, that paper with wet glue has a demonstrable difference as opposed to dry paper or paper without glue.

The paper may be held a fixed distance from detecting pates, and the area of the plates is held constant by design. The moisture in the paper manifests itself by changes in the value of “C” in the above formula. This value is detected and compared with acceptable limits and decisions are made by appropriate software to accept or reject a defective product. Additionally, considerations for external variables may be addressed by the addition of a reference sensor. The purpose of the reference sensor is to measure the material before the glue is applied and subtract this measured value from the sensor measuring the paper after the glue is applied. The remainder from this calculation represents only the moisture content of the glue. All other variables are nullified. In this way, it is possible to utilize this technology to detect moisture content in additional applications/processes besides glue.

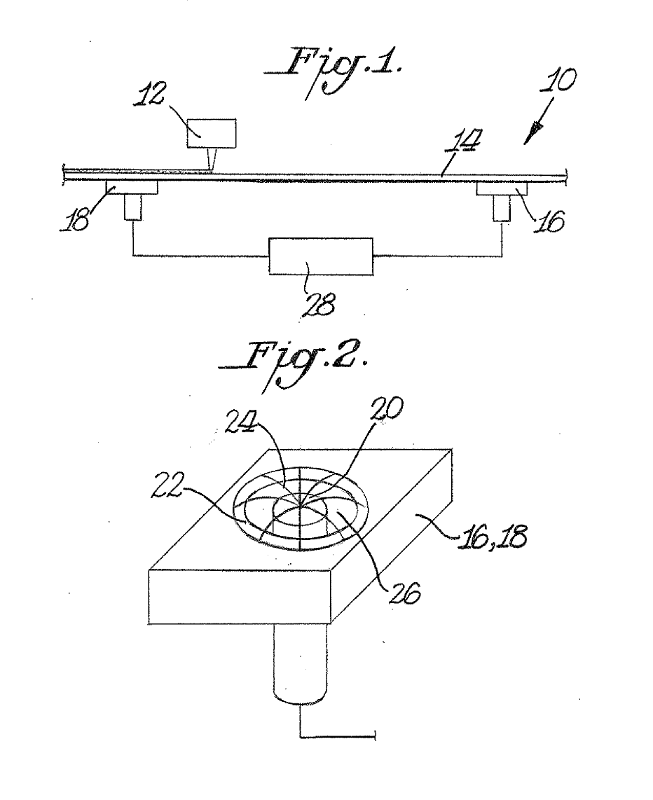

Referring in more particularly to the drawings, FIG. 1 illustrates a system 10 for detecting the presence/absence of glue 12 applied to an endless paper substrate 14 traveling at a high rate of speed. The paper substrate may comprise tipping paper, for example, used to secure a cigarette filter to a wrapped tobacco rod after the filter and tobacco rod are joined together. As explained more fully below, system 10 includes first and second direct contact capacitive sensors 16, 18, one for determining the relative permittivity or dielectric constant of the dry paper and the other for determining the relative permittivity or dielectric constant of the paper with wet glue applied thereto.

Each sensor 16, 18 may comprise a generally flat surface having a first sensing plate in the form of an inner ring 20 and a second sensing plate in the form of an outer ring 22. When energized an electric field 24 is produced between the rings. A gap 26 is defined between the rings, and as explained above when the area of the plates or rings 20, 22 and the gap 26 between them remains fixed the capacitive value in the above formula changes proportionately with the relative permittivity or dielectric constant of the material placed between the two rings 22, 24.

The first sensor 16 outputs a signal to a control box 28 which is representative of the dielectric constant of the dry paper 14 while the second sensor 18 outputs a signal to control box 28 representative of the dielectric constant of the paper 14 and the glue 12. When the difference between the signals is significant, the process continues. On the other hand, when there is little or no difference, such condition is an indication of the absence of glue and corrective measures are taken.

Glue presence measurement utilizing capacitive detection allows for accurate measurement of the presence/absence of glue. The utilization of direct contact sensors 16, 18 on the non-glued side of the paper 14 eliminates the effect of ‘flutter’ on the detection system. Additionally, by using a capacitive sensor, the effects of humidity and/or air density are eliminated. Also, since each detector receives its power from the same source 28, electrical noise/power supply variation is nullified as well. The system 10 is quite accurate because the ‘trigger’ for detecting a fault condition is based on a comparison of the input signals before and after glue is applied as opposed to a ‘set’ threshold value. In this way, variations in paper thickness/density are forgiven.

FIG. 1 represents glue detection for a single side of the paper 14. However, to detect the presence of glue on both the front and rear edge of the paper, for example, a duplicate detection system is required. The reference detector 16 can be utilized by both signal conditioning modules.

With the reference sensor 16 the intrinsic value of the ‘paper’ or product other than glue is subtracted from the output of sensor 18. In this way the accuracy of the detection device 10 is significantly improved. Moreover, the present detection device is ‘self calibrating’ and self adjusting. In this way, little if any human intervention is required.

What is claimed is:

1. A glue application detection system comprising a continuous paper substrate moving in a downstream direction along a path of travel, a glue applicator for applying glue to selected portions of an upper surface of the paper substrate, a first direct contact capacitive sensor under the paper substrate upstream of the glue applicator and in direct contact with an under surface of the substrate constructed and arranged to produce a first signal representative of the dielectric constant of the paper substrate, a second direct contact capacitive sensor under the paper substrate downstream of the glue applicator and in direct contract with an under surface of the substrate with glue thereon constructed and arranged to produce a second signal representative of the dielectric constant of the paper substrate with glue thereon, and a control for determining differences between the first and second signals thereby indicating that glue has been applied to the paper substrate.

2. A glue application detecting system as in claim 1 wherein each of the first and second direct contact capacitive sensors includes a flat surface having a first plate in the form of an inner ring and a second plate in the form of outer ring with a gap between the rings.

3. A method of detecting the presence/absence of glue applied to a paper substrate comprising the steps of:
(a) moving a continuous paper substrate in a downstream direction along a path of travel;
(b) applying glue to selected portions of an upper surface of the paper substrate;
(c) positioning a first direct contact capacitive sensor under the paper substrate upstream of the glue applicator and in direct contact with an under surface of the substrate for producing a first signal representative of the dielectric constant of the paper substrate;
(d) positioning a second direct contact capacitive sensor under the paper substrate downstream of the glue applicator and in direct contact with an under surface of the substrate with glue thereon for producing a second signal representative of the dielectric constant of the paper substrate with glue thereon; and
(e) determining differences between the first and second signals thereby indicating that glue has been applied to the paper substrate.
